(19) United States
(12) Patent Application Publication
(10) Pub. No.: US 2005/0078682 A1
(43) Pub. Date: Apr. 14, 2005

(54) Method for transmitting real time multimedia datain ethernet network

(76) Inventors: Jin-Hee Kim, Suwon-si (KR); Jong-Hwa Lee, Suwon-si (KR); Ji-Eun Keum, Suwon-si (KR); Jae-Yeon Song, Seoul (KR); Se-Youn Lim, Seoul (KR); Yoon-Sun Lee, Seoul (KR); Seo-Won Kwon, Seoul (KR)

Correspondence Address: CHA & REITER, LLC, 210 ROUTE 4 EAST STE 103, PARAMUS, NJ, 07652, US

(21) Appl. No.: 10/915,084

(22) Filed: Aug. 9, 2004

(30) Foreign Application Priority Data
Oct. 14, 2003 (KR) 2003-71496

(51) Int. Cl. H04L 12/28

(52) U.S. Cl. 370/395.5

(57) ABSTRACT

A method for effectively implementing real time multimedia data transmission in an Ethernet network that operates in a CSMA/CD (Carrier Sense Multiple Access/Collision Detect) scheme. Real time data gets priority over general data, and uses an MPCP (Multi-Point Control Protocol) of the IEEE 802.3ah EPON to prevent a collision from occurring in real time data transmission, and also prevents delay time variation. An RT-IFG (Real Time Inter-Frame Gap) is defined for real time data, shorter than an IFG, to give priority to the real time data over general Ethernet data. The MPCP is used for transmission of real time data without collision between the real time data.

### CLAIM OF PRIORITY

This application claims priority to an application entitled “METHOD FOR TRANSMITTING REAL TIME MULTIMEDIA DATA IN ETHERNET NETWORK”, filed in the Korean Intellectual Property Office on Oct. 14, 2003 and assigned Serial No. 2003-71496, the contents of which are hereby incorporated by reference.

### BACKGROUND OF THE INVENTION

1. Field of the Invention

The present invention relates to multimedia transmissions using networks such as Ethernet. More particularly, the present invention relates to a method for effectively implementing real time multimedia data transmission in an Ethernet network operating in a CSMA/CD (Carrier Sense Multiple Access/Collision Detect) scheme.

2. Description of the Related Art

Ethernet is a well-known networking technology in which a client intending to transmit data first determines whether another client (or computer) is communicating on a network, and transmits the data if there is no signal being transmitted on the network. Thus, the Ethernet is prone to collisions when a number of nodes at the same time ascertain that there is no signal being transmitted and attempt to transmit data during the same timeframe, and/or overlapping timeframes. Carrier Sense Multiple Access/Collision Detect (CSMA/CD) is a communication control method that monitors the collision of transmissions by nodes and retransmits a signal after holding the signal for a predetermined time if a collision occurs.

In order to illustrate a media control method based on the CSMA/CD, let us assume that one node intends to use a line on a network. Initially, the node checks the status of the line of the network. If there is no data on the line of the network while no other nodes use the network, there will be no problem, allowing the node to perform desired processes.

However, if one node (or a first node) attempts to use a line of the network while another node (or a second node) is already the line of the network, a collision of the transmitted data occurs on the line. Once the collision occurs, the first node waits until the second node already using the line completes use of the line. Then, after a predetermined time, the first node reattempts use of the line. This particular method of retransmitting data after waiting the predetermined time is called a “random backoff”. The wait time after a collision occurs can be selected to reduce the possibility of further collisions, and it usually depends on a timer provided in a node. Each node must be given a different wait time to prevent further collisions. The different wait time is fixedly set in the node or obtained using a random number generator.

FIGS. 1, 2a and 2b are used to illustrate a conventional CSMA/CD method. With reference to FIG. 1, there is a block diagram showing the configuration of a conventional Ethernet network. The conventional Ethernet network includes an L2/L3 switch 11, a hub 12 and devices 13, 14 and 15 (devices A, B and C, respectively). The L2/L3 switch 11 receives data from an upper level network, and switches and transfers the received data to the devices 13, 14 and 15, which are terminations of the network. The hub 12 distributes the data to the devices 13, 14 and 15. This Ethernet network differs from an Ethernet PON (Passive Optical Network) in that the distributing element (i.e., the hub 12) is not a passive element but an active element so that each device can perform carrier sensing when one device transmits data.

FIGS. 2a and 2b are graphs illustrating the timing sequence of a devices using CSMA/CD in the conventional Ethernet network. As shown in FIG. 2a, if devices 14 and 15 (devices B and C) intend to transmit packets as denoted by reference numerals 22 and 23 when a device 13 (device A) is already using the network as denoted by reference numeral 21, the devices 14 and 15 wait until the device 13 terminates data transmission, and then additionally wait a time corresponding to an IFG (Inter-Frame Gap) 24 (hereinafter referred to as an “IFG time 24”) to transmit the packets since the device 13 is already using the network.

Here, a collision still occurs since the devices 14 and 15 transmit the packets at the same time as denoted by reference numerals 22 and 23. FIG. 2b shows how the collision is avoided in the CSMA/CD method. If the devices 14 and 15 detect a collision, they transmit packets after waiting random delays 25 and 26, respectively, in addition to the IFG time 24. In more detail, if a collision occurs, the transmitting devices 14 and 15 each detect a corresponding malfunction, and transmit a bit sequence called a “jam” over the network. The jam allows other devices desiring to transmit to detect that the collision. Thus, after waiting a random period of time, each device reattempts to transmit packets, and enters an initial operating state.

Referring to FIG. 2b, since the random delay 25 of the device 14 (device B) is shorter than the random delay 26 of the device 15 (device C), packets “22” of the device 14 are first transmitted. The device 15 (device C) will attempt transmission of the packet 23 after waiting until device 14 terminates transmission, plus an IFG and another random delay. It is also possible that during the period where device 14 terminates and before the random delay of device 15 (device C) begins, another device, such as A could begin transmission, which would cause device 15 to have to wait again.

In view of the above discussion of collision avoidance as known in the prior art, it can be seen that the above CSMA/CD method employed in the conventional Ethernet is not effective in transmitting real time multimedia data due to some characteristics of the CSMA/CD method.

The random delays introduced by CSMA/CD create problems for multimedia transmission. In contrast, if a constant delay value (rather than random) would generated for each packet in real time multimedia data transmission, there is no problem in providing the multimedia service, such an audio or video service, except for the multimedia service being delayed for a time corresponding to the generated delay value.

However, according to the CSMA/CD method, if a collision occurs, as the data transmission is randomly delayed, and there is not even a guarantee that priority would be placed on the delayed data transmission even after being randomly delayed. Thus, after a packet is transmitted, the next packet transmission may be delayed for a significant amount of time that is not predictable. On the other hand, if a packet transmission has no collision issues other then waiting for a free period to transmit, the packet can be transmitted after being delayed only for the IFG time, thereby causing a large delay time variation in the transmission of real time multimedia data packets.

In the real-time multimedia data transmission in which audio or video information is sampled and transmitted at intervals of a predetermined period, if each packet is transmitted with a variable delay time as described above, a receiving device cannot fetch data in synchronization with predetermined times, so that music may be choppy, or an image may be abruptly broken, causing a user to feel unpleasant or uncomfortable.

One way to attempt to alleviate problems such as those described above due to the delay time variation may be resolved by providing a buffer in the receiving device. The size of the delay time variation is taken into account when providing the buffer in the receiving device. Incoming packets or data with variable delay values are temporally stored in the buffer and then output therefrom in synchronization with predetermined times. Although the packets or data have different delay values, users can always receive real time data regularly after some time delay (corresponding to packet transmission duration plus buffering delay) if the capacity of the buffer is large enough to cover the variation in the delay values of the packets or data. In this manner, the buffer enables the users to receive a real time data service without inconvenience.

However, since the Ethernet network employs the CSMA/CD method as a standard, an instantaneous delay still occurs due to the necessary backoff algorithm when a collision occurs. In addition, since each device performs a retransmission after a random delay, the difference between the size of a delay time variation when a collision occurs and the size of a delay time variation when no collision occurs is very large. Further, it is not easy to predict the size of a delay time variation for the buffering since the delay value randomly varies each time a collision occurs. Thus, in the Ethernet network, it is difficult to overcome the problems due to the delay time variation by the buffering at the receiver, and there is a need for a better method of handling delays.

### SUMMARY OF THE INVENTION

Therefore, the present invention has been made at least in part in view of some of the above-mentioned problems. The present invention provides a method for transmitting real time multimedia data in an Ethernet network, which gives priority to real time data over general data, and uses an MPCP (Multi-Point Control Protocol) of the IEEE 802.3ah EPON to prevent a collision from occurring in real time data transmission, and also prevents the delay time from varying.

In accordance with one aspect of the present invention, the above method for transmitting real time multimedia in an Ethernet network with a priority of general data can be accomplished by performing the steps of a) defining an RT-IFG (Real Time Inter-Frame Gap) for real time data, shorter than an IFG, to give priority to the real time data over general Ethernet data; and b) using an MPCP (Multi-Point Control Protocol) for transmission of real time data without collision between the real time data.

In accordance with another aspect of the present invention, there is provided a method for transmitting real time multimedia data in an Ethernet network without collisions occurring between the real time data, comprising the steps of a) selecting a master device for applying an MPCP protocol to a predetermined number of devices included in the Ethernet network; b) by the predetermined number of devices, requesting bandwidths for data transmission from the master device; c), by the master device, dividing a bandwidth corresponding to one cycle for data transmission into the requested bandwidths, and allocating the divided bandwidths respectively to the predetermined number of devices, and then transferring information of the allocated bandwidths to the predetermined number of devices; and d) by the predetermined number of devices, transmitting data in the allocated bandwidths.

### BRIEF DESCRIPTION OF THE DRAWINGS

The above and other descriptions, as well as some of the advantages of the present invention will be more clearly understood from the following detailed description taken in conjunction with the accompanying drawings, in which:

FIG. 1 is a block diagram showing the configuration of a conventional Ethernet network;

FIGS. 2a and 2b are a diagram illustrating how a CSMA/CD method is performed in the conventional Ethernet network;

FIG. 3a is a packet transmission diagram illustrating an IFG (Inter-Frame Gap) currently used in the Ethernet;

FIG. 3b is a packet transmission diagram illustrating an RT-IFG (Real Time-Inter-Frame Gap) for giving priority to real time data in Ethernet transmission according to the present invention;

FIG. 4 is a block diagram showing the configuration of a conventional Ethernet PON;

FIG. 5 is a signal flow diagram illustrating a general MPCP protocol in the Ethernet PON;

FIG. 6 is a block diagram showing the configuration of an Ethernet network to which a hub is connected according to an aspect of the present invention;

FIGS. 7A and 7B are diagrams illustrating exemplary data transmission in the Ethernet network according to an aspect of the present invention;

FIG. 8 is a diagram showing a general Ethernet frame into which a timestamp is inserted according to one aspect of the present invention;

FIG. 9 is a diagram showing a general Ethernet frame into which a timestamp is inserted according to another aspect of the present invention;

FIG. 10 is a flow chart showing an aspect of an initialization procedure of the Ethernet network according to the present invention when each device in the Ethernet network is powered on;

FIG. 11 is a flow chart showing an embodiment of the operation of an Ethernet network according to the present invention when each device in the Ethernet network is powered off; and

FIG. 12 is a flow chart showing an aspect of a device discovery operation in the initialization procedure of the Ethernet network according to the present invention when each device in the Ethernet network is powered on.

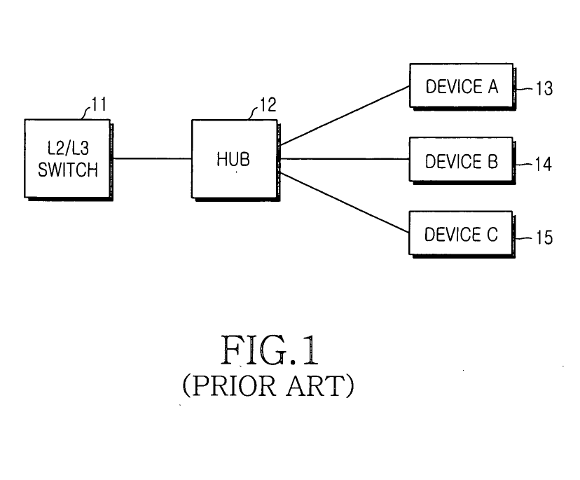

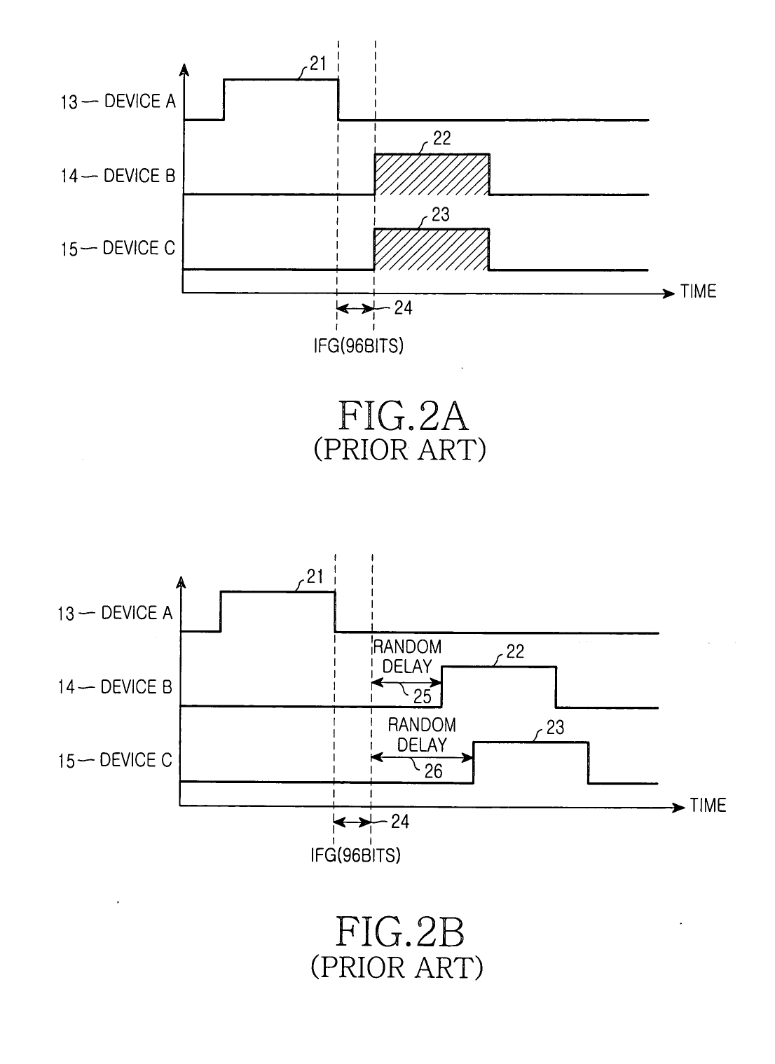

### DETAILED DESCRIPTION

Now, embodiments of the present invention will be described in detail with reference to the annexed drawings. In the drawings, the same or similar elements are denoted by the same reference numerals even though they are depicted in different drawings. For the purposes of clarity and simplicity, a detailed description of known functions and configurations incorporated herein will be omitted as it may obscure the subject matter of the present invention.

According to an aspect of the present invention, in an Ethernet network, priority for transmission of data is given to real time data over general data to permit real time data transmission with as little a delay as practical. In addition, the bandwidth allocated to each device for allowing transmission without collision between real time data, and the real time transmission data of the devices are time-synchronized with each other. These features of the present invention will now be described in detail with reference to the drawings.

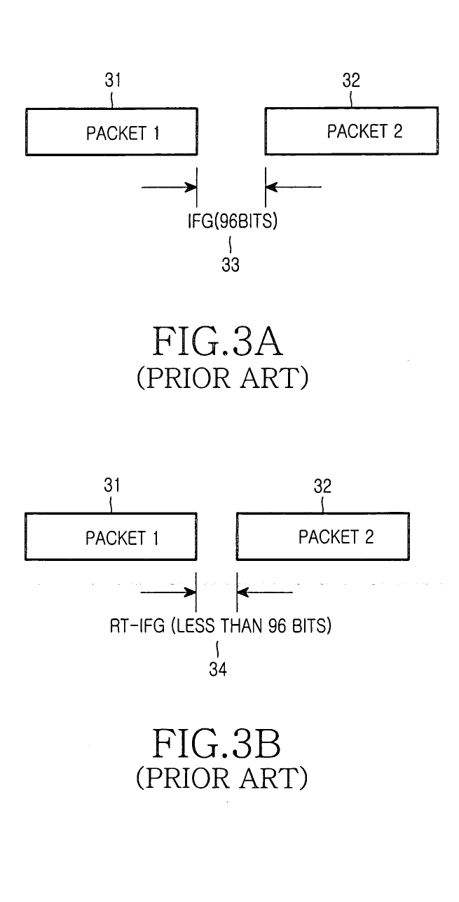

FIG. 3a is a conventional packet transmission diagram illustrating an IFG (Inter-Frame Gap) currently used in the Ethernet. FIG. 3b is a packet transmission diagram illustrating an RT-IFG (Real Time-Inter-Frame Gap) for giving priority to real time data in Ethernet transmission according to the present invention.

The conventional IFG was defined in IEEE (Institute of Electrical and Electronics Engineers) 802.3. As shown in FIG. 3A, according to the definition, the IFG is a minimum bit time between two packets (in this case a packet 31 and a packet 32), and consists of 96 bits.

The IFG was designed originally for preventing a specific device from monopolizing an Ethernet bus, but according to the present invention, an appropriate utilization of the characteristics of the IFG may allow collision-free transmission of the next packet 32 even while using the CSMA/CD scheme, as follows.

If transmission of the next packet 32 has started after waiting a time corresponding to an RF-IFG 34 (also referred to as an “RF-IFG time 34”) shorter than a time corresponding to the conventional IFG 33 (also referred to as an “IFG time 33”) as shown in FIG. 3b, the next packet 32 can be preferentially transmitted without collision.

In other words, in order to give priority to the real time data over the general Ethernet data, the present invention employs an RT-IFG 34, instead of the conventional IFG 33, for transmission of real time data packets. The RT-IFG 34 is defined to be much smaller than the conventional 96 bits of the IFG 33. The use of the RT-IFG 34 allows fast transmission of the real time data packet without collision with the Ethernet data packet that must wait the conventional 96-bit time to be transmitted.

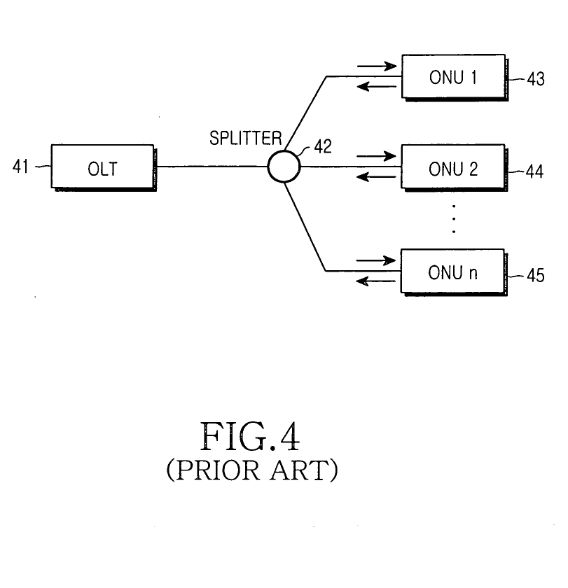

FIG. 4 is a block diagram showing the configuration of a conventional Ethernet PON. The Ethernet PON includes an OLT 41, a splitter 42 and a number of ONUs 43, 44 and 45. The splitter 42 is connected with the OLT 41 via a single optical fiber, and distributes signals to the ONUs 43, 44 and 45.

In the downstream transmission (represented by arrows pointing toward the ONUs), all data from the OLT 41 is equally distributed to the ONUs 43, 44 and 45, without problem. However, in the upstream transmission (represented by arrows pointing toward the OLT 41), a data collision is inevitable since each ONU in the PON cannot determine whether another ONU is currently transmitting data. The reason that each ONU cannot determine if another ONU is currently transmitting data is because with the use of an active element, a general Ethernet network can provide information as to whether a data transmission channel of interest is occupied, but the PON cannot provide the information because it uses a passive element. Thus, the PON uses an MPCP (Multi-Point Control Protocol) to prevent the collision, rather than CSMA/CD. According to the MPCP protocol, the OLT, serving as a master, allocates a bandwidth for upstream transmission to each ONU before the ONUs transmit data, and then the ONUs carry data for transmission in their own bandwidths allocated respectively to the ONUs.

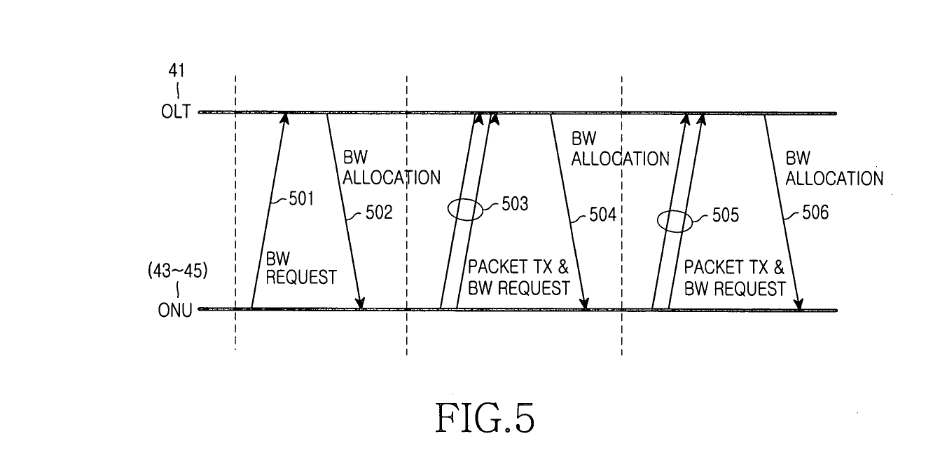

FIG. 5 is a signal flow diagram illustrating a general MPCP protocol in the Ethernet PON.

As shown in FIG. 5, first, each ONU 43 to 45 requests an OLT 41 to allocate a bandwidth for upstream data transmission (501). Each ONU 43 to 45 receives a bandwidth allocation (502, 504, 506) signal therefor from the OLT 41 in response to the request (502).

Each ONU 43 to 45 carries packet data for transmission in the allocated bandwidth, while requesting that the OLT 41 allocate a bandwidth for the next transmission (503, 505). Each ONU 43 to 45 receives a bandwidth allocation signal therefor from the OLT 41 in response to the request (502,504, 506).

The present invention employs a protocol wherein the devices are allocated their own transmission time ranges in one transmission cycle, thereby allowing data transmission without collision.

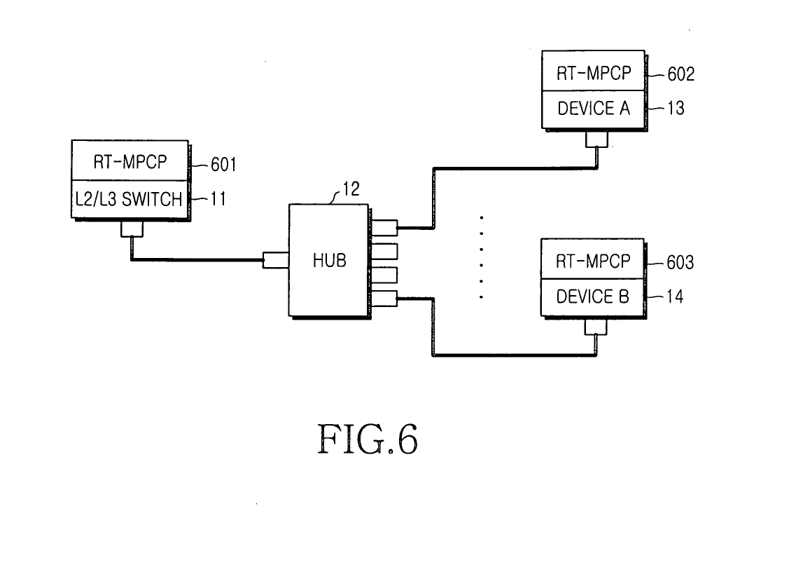

FIG. 6 is a block diagram showing the configuration of an Ethernet network to which a hub is connected according to an aspect of the present invention. As shown in FIG. 6, the Ethernet network differs from the EPON network shown in FIG. 5, particularly in that all devices can perform carrier sensing when one device transmits data because an active element (i.e., the hub 12), rather than a passive splitter 42, is used for connection to the Ethernet network.

Therefore, the Ethernet network of FIG. 6 has a network structure that introduces a protocol such as the MPCP into the conventional Ethernet structure to avoid the collision. In other words, the Ethernet network of FIG. 6 allows a new MPCP layer (referred to as an “RT-MPCP” for convenience) to operate in the Ethernet network.

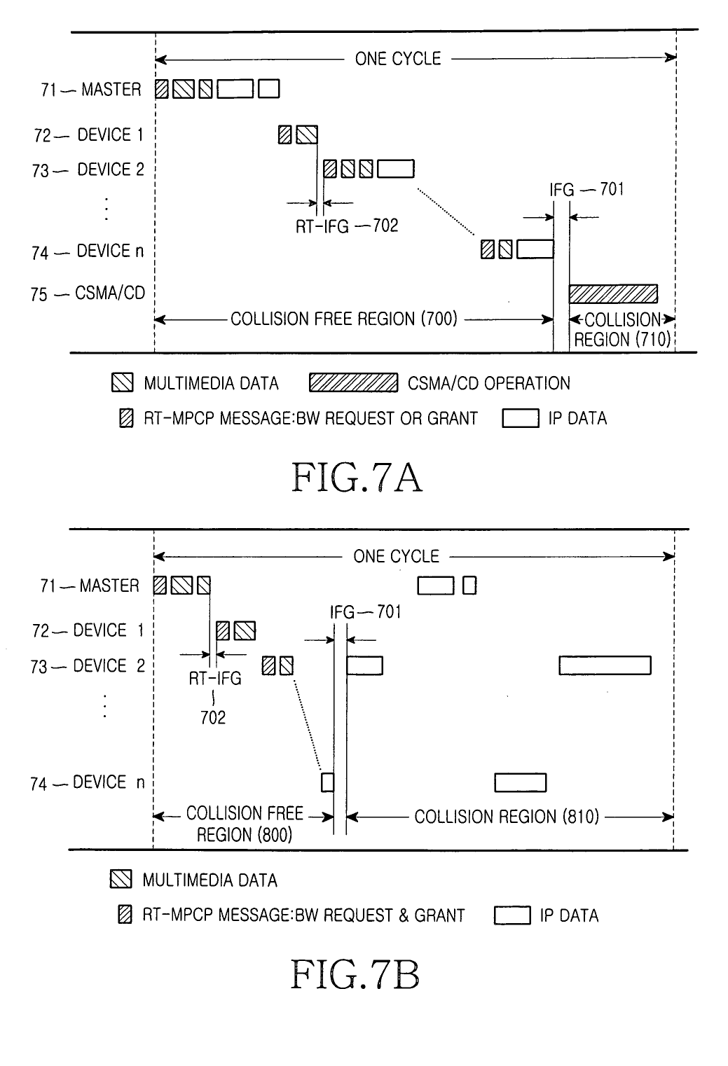

Thus, the RT-MPCP according to the present invention operates based on CSMA/CD, as opposed to the conventional MPCP for Ethernet PONs. Accordingly, the RT-MPCP operates under different principles from the Ethernet PON MPCP, and details thereof are described below with reference to FIGS. 7a and 7b, infra.

FIGS. 7a and 7b are diagrams illustrating exemplary data transmission in the Ethernet network according to an aspect of the present invention. According to the present invention, with reference to the exemplary data transmission of FIGS. 7A and 7B and the Ethernet network of FIG. 6, real time data transmission in the Ethernet network will be described in more detail. It should be noted that according to the present invention, there is shown one master and a plurality of devices.

Devices 72, 73 and 74 transmit RT-MPCP bandwidth allocation request messages to a master 71 to be allocated bandwidths needed for the devices 72, 73 and 74. The RT-MPCP bandwidth allocation request messages can be transmitted in collision regions 710 and 810 or collision free regions 700 and 800 (shown in FIGS. 7A and 7B, respectively).

Based on bandwidth requests received from the devices 72, 73 and 74 and on its own bandwidth request, the master 71 divides a predetermined bandwidth (corresponding to one transmission cycle) into bandwidths respectively for the devices 72, 73 and 74 and the master 71 according to the QoS (Quality of Service), the bandwidth request level or the like. Subsequently, information regarding the bandwidth allocated to the devices 72, 73, and 74 is transferred to said devices, along with a transmission start or end time via the RT-MPCP bandwidth allocation messages.

The devices 72, 73 and 74 will transmit data at their own transmission times, assigned according to the RT-MPCP bandwidth allocation messages received from the master 71, in the collision free regions 700 and 800 (shown in FIGS. 7A and 7B, respectively) without collision between data of the devices 72, 73 and 74. When data is transmitted in the collision free regions 700 and 800, the distance between the packets is maintained at the RT-IFG 702.

The devices (including the master) may perform two data transmission methods, respectively, in the collision free regions 700 and 800 in one transmission cycle. In the first method (FIG. 7A), the devices transmit all data for transmission (including real time multimedia data and general IP data) in the collision free region 700 in one transmission cycle. In the second method (FIG. 7B), the devices transmit only the real time multimedia data in the collision free region 800 in one transmission cycle.

In the collision regions 710 and 810, other than the collision free regions 700 and 800, the devices perform data transmission based on the conventional CSMA/CD scheme. When data is transmitted in the collision regions 710 and 810, the distance between packets is maintained at the IFG 701.

In addition, the clocks of the master 71 and the devices 72, 73 and 74 should be synchronized with each other in order to operate according to MPCP in which a transmission time region is allocated to each of the master 71 and the devices 72, 73 and 74. If the master 71 in the network appoints a predetermined transmission start and end times to the devices 72, 73 and 74, the devices 72, 73 and 74 can transmit data without causing any collision only by transmitting data at their own predetermined times appointed by the master 71. However, in order for the devices 72, 73, and 74 to synchronize their operating times with the predetermined times appointed by the master 71, the clocks of the devices must be synchronized with each other.

Thus, the present invention suggests that an Ethernet frame include a timestamp.

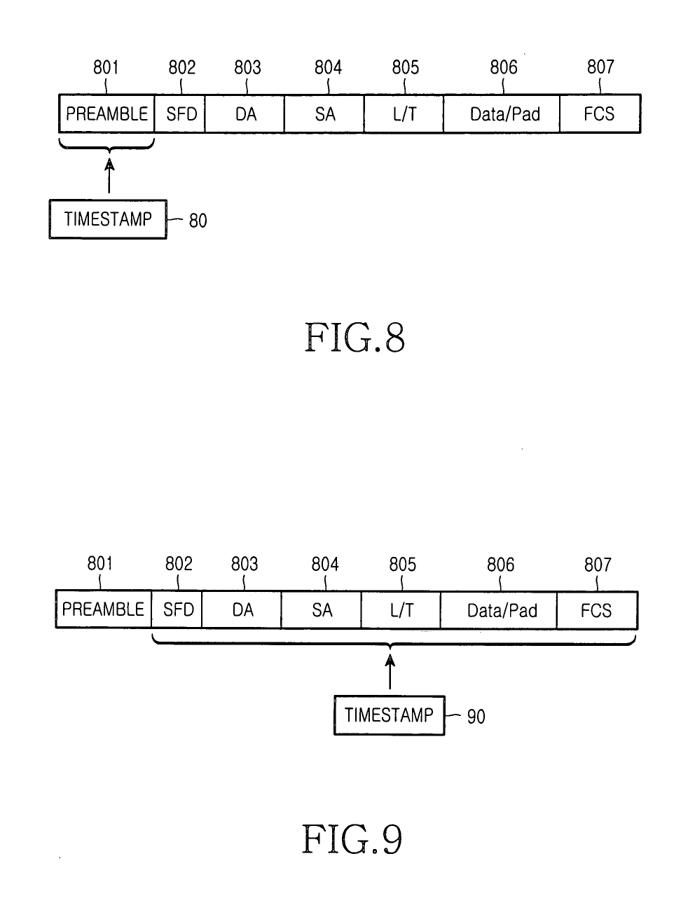

FIGS. 8 and 9 are diagrams showing general Ethernet frames into each of which a timestamp is inserted according to the present invention. The timestamp may be included in a preamble 801 as shown in FIG. 8 or in at least one of the remaining fields 802 to 807 as shown in FIG. 9.

The timestamp included in the Ethernet frame serves two functions. The first function synchronizes the clocks of the devices (including the master). The second permits a receiver to predict the amount of transmission delay in delay-sensitive data transmission.

There are two processes used to implement the operations described above. The first process is to select one of the devices as a master and the second is to allow the master to detect power on/off of each device for the RT-MPCP data transmission.

The master receives a bandwidth request from each of the other devices, and distributes a given bandwidth to each device according to the QoS or various other aspects. Then, the master uses the timestamp to allow clocks of the other devices to be synchronized with the clock of the master.

The master having such functions is selected from the devices according to the following rules. First, a device having a processing capability to allocate a bandwidth may be selected as a master (first rule). Among devices satisfying the first rule, a device near the L2/L3 switch 11 is selected as a master (second rule).

Among devices satisfying the second rule, a device near a metro or backbone network is selected as a master (third rule).

Among devices satisfying the third rule, a master is selected according to its MAC address size (fourth rule).

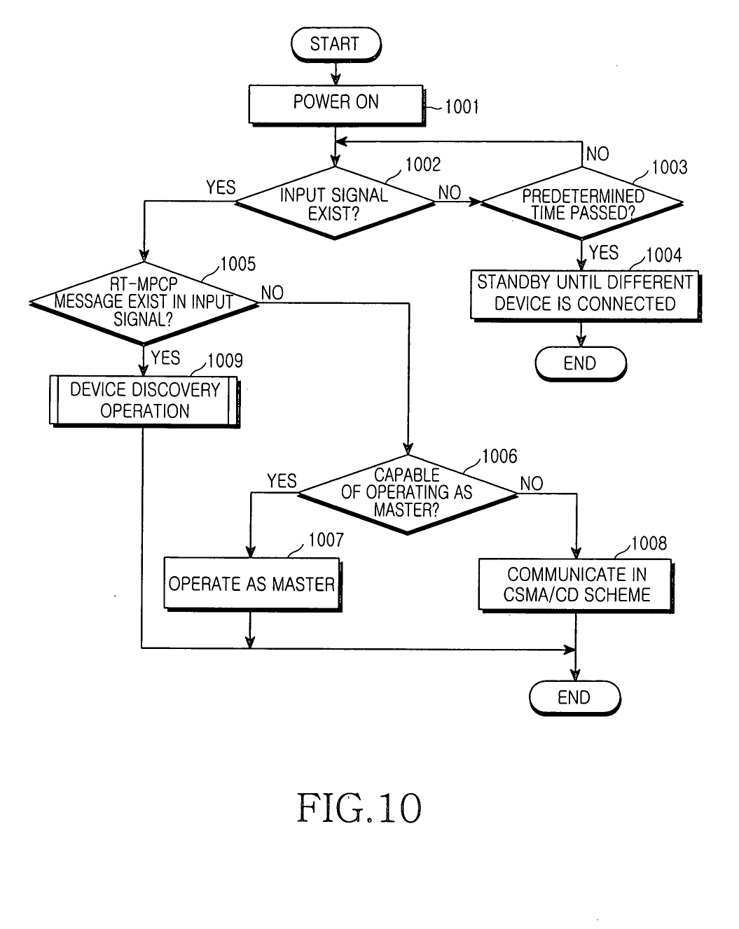

According to the present invention, the operation of an Ethernet network when each of the devices (including the master) is powered on will now be described with reference to FIG. 10.

FIG. 10 is a flow chart showing an aspect of an initialization procedure of the Ethernet network according to the present invention, when each device in the Ethernet network is powered on. If a specific device is powered on (1001), it is detected whether an incoming signal exists in an input port of the specific device (1002). If no incoming signal exists in the input port even when a predetermined period of time has passed (1003), the operation remains in the standby state until a different device is connected to the network (1004).

However, if it is detected at step 1002 that an incoming signal exists in the input port, it is confirmed whether an RT-MPCP message exists in the incoming signal (1005). The reason why this confirmation is possible is that the master sends an RT-MPCP message at least once in a predetermined period to allow the devices to maintain synchronization of their clocks.

If the confirmation at step 1005 is negative (i.e., if there is no RT-MPCP message in the predetermined period), it is checked whether the specific device is adapted for operating as a master (1006). If the specific device is adapted for operating as a master, then it will being operation as the master (1007). As described above, if a network is composed of one master adapted for operating in the RT-MPCP scheme and a number of devices that are not adapted for operating in the RT-MPCP scheme and operate in the CSMA/CD MAC scheme, the master schedules and sends only its own data (through a specific bandwidth), and opens the remaining bandwidth as a competition region, allowing the devices operating in the CSMA/CD MAC scheme to communicate with each other.

If the specific device does is not adapted for operating as a master (1006), then the specific device communicates with other devices in the CSMA/CD scheme (1008).

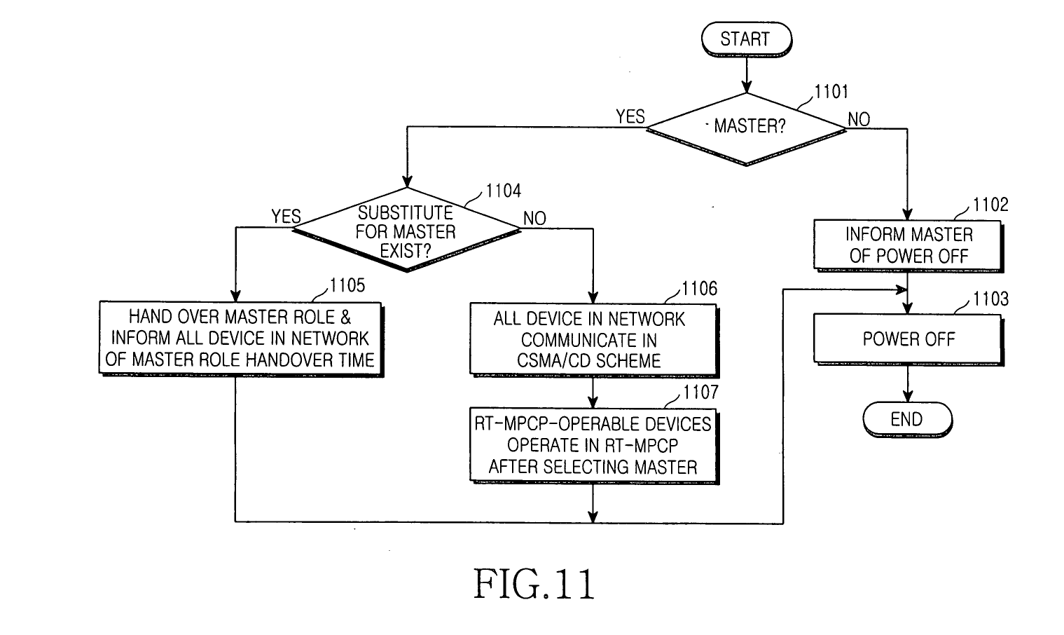

On the other hand, if the confirmation at step 1005 is positive (i.e., if an RT-MPCP message is detected in the predetermined period), a device discovery operation is performed (1009). According to the present invention, if each device in the Ethernet network is going to power off, the following operation is performed before turning off the power, as shown in FIG. 11.

First, it is checked whether a specific device to be powered off is a master (1101).

If the specific device to be powered off is not the master, the specific device informs the master that the specific device will be powered off (1102), and is then powered off (1103).

On the other hand, if the specific device to be powered off is the master (1101), it is checked whether there is an alternative device (other than the specific device) that can substitute for the master (1104).

If the checked result at step 1104 is that the alternative device that is adapted for substituting for the master is present, the master role is handed over to the alternative device, and the other devices in the network are informed of when the master role is handed over (1105).

If the checked result at step 1104 indicates that there is no alternative device adapted for substituting for the master, all of the devices in the network communicate in the CSMA/CD scheme (1106). This process 1106 is performed also when the master is abruptly powered off.

The devices, which can operate in the RT-MPCP scheme, inform each other of their capability, so that a new master is selected therefrom based on the master selection rule, and then the general RT-MPCP operation is performed (1107).

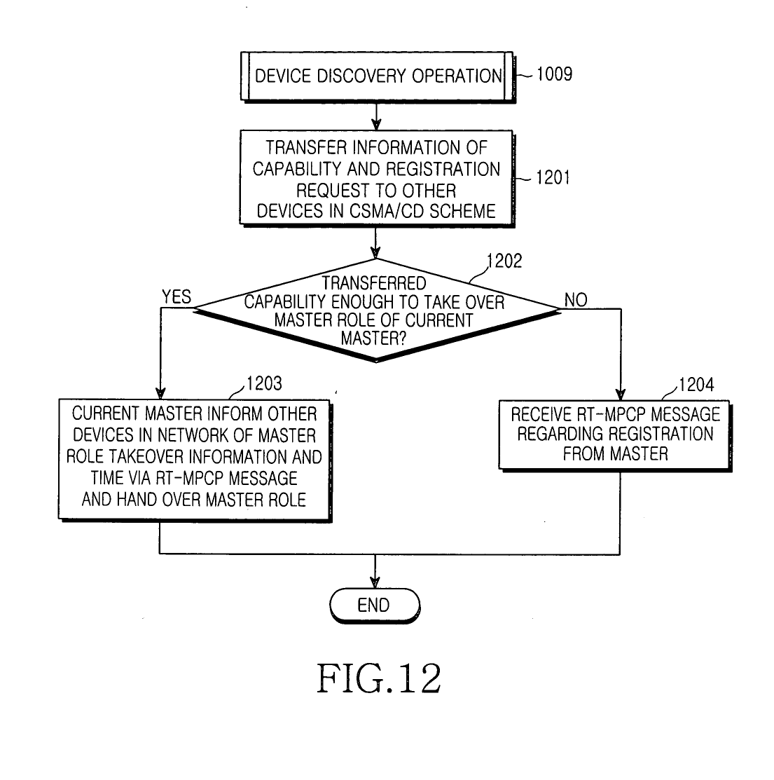

FIG. 12 is a flow chart showing an aspect of a device discovery operation in the initialization procedure of the Ethernet network according to the present invention when each device in the Ethernet network is powered on.

If it is confirmed that there is an RT-MPCP message in the incoming signal at step 1005 (in the initialization procedure according to the present invention shown in FIG. 10 when each device in the Ethernet network is powered on), the specific device transfers information of capability of the specific device and information of a registration request thereof to other devices in the CSMA/CD scheme (1201).

It is checked whether the capability of the specific device included in the transferred information allows the specific device to take over the master role of the current master, according to the master selection rule (1202).

If the checked result at step 1202 is positive (i.e., if the specific device can take over the master role of the current master), the current master uses an RT-MPCP message to inform the other devices in the network of the takeover of the master role by a specific device and when the specific device takes over the role of the current master, and then hands over the master role to the specific device (1203).

If the checked result at step 1202 is negative (i.e., if the current master can maintain the master role), the specific device receives an RT-MPCP message regarding registration of the specific device from the current master (1204).

As apparent from the above description, the present invention introduces an MPCP (Multi-Point Control Protocol) concept of the IEEE 802.3ah EPON under study into the conventional CSMA/CD-based Ethernet network, so as to prevent collisions between real time data.

The present invention also defines a new type of IFG (Inter-Frame Gap), so as to give priority to transmission of real time data over that of general Ethernet data.

Further, the present invention defines a timestamp field for inserting time information in a conventional Ethernet packet, so as to achieve synchronization for the MPCP.

The method according to the present invention as described above can be embodied as a program, which can be stored in a recording medium, such as a CD ROM, a RAM, a floppy disk, a hard disk, a magneto-optical disk, etc., in the computer-readable format.

Although the preferred aspects of the present invention have been disclosed for illustrative purposes, those skilled in the art will appreciate that various modifications, additions and substitutions are possible, without departing from the scope and spirit of the invention as disclosed in the accompanying claims.

1. A method for transmitting real time multimedia data and general data in an Ethernet network, comprising the steps of:
(a) defining an RT-IFG (Real Time Inter-Frame Gap) for real time data that is shorter in duration than an Inter-Frame Gap (IFG), to give priority to the real time data over general Ethernet data; and
(b) using an MPCP (Multi-Point Control Protocol) for transmission of real time data without collision between the real time data.

2. The method according to claim 1, wherein a timestamp is included in an Ethernet frame used in the Ethernet network to apply the MPCP protocol to the real time data.

3. The method according to claim 2, wherein the timestamp is included in a preamble of the Ethernet frame.

4. The method according to claim 1, wherein said step (a) includes the step of defining an RT-IFG having a smaller number of bits than an IFG having 96 bits, and applying the RT-IFG to the real time data.

5. The method according to claim 1, wherein said step (b) includes the following sub-steps:
(i) selecting a master device for applying the MPCP protocol to a predetermined number of devices included in the Ethernet network;
(ii) requesting bandwidths for data transmission from the master device by the predetermined number of devices;
(iii) dividing a bandwidth corresponding to one cycle for data transmission into the requested bandwidths, and allocating the divided bandwidths respectively to the predetermined number of devices, and then transferring information of the allocated bandwidths to the predetermined number of devices by the master device; and
(iv) transmitting data in the allocated bandwidths by the predetermined number of devices.

6. The method according to claim 2, wherein said step (b) includes the following sub-steps:
(i) selecting a master device for applying the MPCP protocol to a predetermined number of devices included in the Ethernet network;
(ii) requesting bandwidths for data transmission from the master device by the predetermined number of devices,;
(iii) dividing a bandwidth corresponding to one cycle for data transmission into the requested bandwidths, and allocating the divided bandwidths respectively to the predetermined number of devices, and then transferring information of the allocated bandwidths to the predetermined number of devices by the master device; and
(iv) transmitting data in the allocated bandwidths by the predetermined number of devices.

7. The method according to claim 5, wherein said step (i) includes the step of determining a device as the master device according to whether said device has a processing capability to allocate a bandwidth, according to whether said device is near an L2/L3 (Layer 2/Layer 3) switch of the Ethernet network, according to whether said device is near a metro network or a backbone network, and according to a MAC address size of said device.

8. The method according to claim 5, wherein said step (iv) includes the step of transmitting data in the allocated bandwidth by each of the predetermined number of devices, said data including a message for requesting a bandwidth in a next data transmission cycle of each of the predetermined number of devices.

9. A method for transmitting real tme multimedia data and general data in an Ethernet network without collision between the real time data, comprising the steps of:
(a) selecting a master device for applying an MPCP protocol to a predetermined number of devices included in the Ethernet network;
(b) requesting bandwidths for data transmission from the master device by the predetermined number of devices;
(c) dividing a bandwidth corresponding to one cycle for data transmission into the requested bandwidths, and allocating the divided bandwidths respectively to the predetermined number of devices, and then transferring information of the allocated bandwidths to the predetermined number of devices by the master device transmitting data in the allocated bandwidths; and
(d) transmitting data in the allocated bandwidths by the predetermined number of devices.

10. The method according to claim 9, wherein said step (a) includes the sub-step of determining a device as the master device according to whether said device has a processing capability to allocate a bandwidth, and according to whether said device is arranged near an L2/L3 (Layer 2/Layer 3) switch of the Ethernet network, and according to whether said device is near a metro network or a backbone network, and according to a MAC address size of said device.

11. The method according to claim 9, wherein said step (d) includes the step of transmitting data in the allocated bandwidth by each of the predetermined number of devices, said data including a message for requesting a bandwidth in a next data transmission cycle of each of the predetermined number of devices.

12. The method according to claim 11, wherein when a specific device included in the network is powered on, the method further comprises the steps of:
(e) checking whether an incoming signal exists in an input port of the specific device, and, if no incoming signal exists therein, then checking for a predetermined period of time as to whether or not an incoming signal exists therein, and then remaining in a standby state until a different device from the specific device is connected to the network;
(f) performing a device discovery operation if an incoming signal exists in the input port of the specific device and if an RT-MPCP message from a master device in the network exists in the incoming signal;
(g) checking whether the specific device is adapted for operating as a master when an incoming signal exists in the input port of the specific device and if no RT-MPCP message from the master device in the network exists in the incoming signal for a predetermined period of time;
(h) allowing the specific device to operate as a master device if the checked result at said step (g) indicates that the specific device is adapted for operating as a master; and
(i) connecting the specific device with devices in the network if the checked result at said step (g) indicates that the specific device is not adapted for operating as a master.

13. The method according to claim 12, wherein said step (f) includes the sub-steps of:
(i) transferring information of capability of the specific device and information of registration request of the specific device in a Carrier Sense Multiple Access/Collision Detect (CSMA/CD) scheme if it is confirmed that the RT-MPCP message exists in the incoming signal;
(ii) checking whether the capability of the specific device included in the information transferred at said step f-1) allows the specific device to take over a current master role of the master device by the master device in the network;
(iii) transferring information of the master role takeover and of when the specific device takes over the master role of the master device to devices in the network via an RT-MPCP message by the master device, and handing over the (iv) receiving an RT-MPCP message regarding registration of the specific device from the master device in the network, if the checked result at said step (ii) indicates that the master device is allowed to maintain the master role.

14. The method according to claim 11, wherein when a specific device included in the network attempts to be powered off, the method further comprises the steps of:
(e) checking whether the specific device attempting to be powered off is a master device in the network;
(f) informing the master device that the specific device will be powered off, and then turning off power of the specific device if the checked result at said step e) indicates that the specific device is not the master device;
(g) checking whether there is an alternative device, other than the specific device, for substituting for the master device if the checked result at said step e) indicates that the specific device is the master device;
(h) handing over a master role of the master device to the alternative device, and informing other devices in the network of when the master role is handed over, and then turning off the power of the specific device if the checked result at said step (g) indicates that the alternative device for substituting for the master device is present; and
(i) turning off the power of the specific device if the checked result at said step (g) indicates that there is no alternative device for substituting for the master device.

15. The method according to claim 14, wherein said step (i) includes the steps of:
(i) communicating in a CSMA/CD scheme by all devices in the network;
(ii), informing each device of capabilities of said devices of adapted for operating in an RT-MPCP scheme of all the devices in the network; and
(iii) returning to said step (a).

16. The method according to claim 9, wherein said one cycle for data transmission is divided into a collision free region where the MPCP protocol is employed and a collision region where the Carrier Sense Multiple Access/Collision Detect (CSMA/CD) scheme is employed.

17. The method according to claim 16, wherein the collision free region employs an RT-IFG smaller than 96 bits, said collision free region being adapted for devices to transmit data said devices being registered in the master device and allocated bandwidth.

18. The method according to claim 16, wherein the collision region employs an IFG of 96 bits, said collision region being adapted for devices to transmit date, said device being registered in the master device and not being allocated bandwidth.

19. The method according to claim 16, wherein the collision free region employs an RT-IFG smaller than 96 bits, said collision free region being adapted for devices registered in the master device and allocated a bandwidth, to transmit real time data.

20. The method according to claim 16, wherein the collision region employs an IFG of 96 bits, said collision region being adapter for devices registered in the master device and not allocated the bandwidth so as to transmit data, other than real time data, of devices registered in the master device and allocated the bandwidth.

21. The method according to claim 16, wherein the master device transmits an RT-MPCP message at least once in a predetermined period to allow all devices in the network to maintain clock synchronization between all the devices.
